(19) United States
(12) Patent Application Publication
(10) Pub. No.: US 2004/0165331 A1
(43) Pub. Date: Aug. 26, 2004

(54) Integrated gas tube holder for gas tube surge arrestors

(76) Inventor: James Neil McDonald JR., Greenacres, WA (US)

Correspondence Address: FISH & NEAVE, 1251 AVENUE OF THE AMERICAS, 50TH FLOOR, NEW YORK, NY, 10020-1105, US

(21) Appl. No.: 10/375,164

(22) Filed: Feb. 25, 2003

(51) Int. Cl. H02H 1/00

(52) U.S. Cl. 361/119

(57) ABSTRACT

A surge arrestor cap can be manufactured with a cavity that is designed to mate with gas tubes directly, without use of a separate holder or spring clip. One end of the gas tube fits inside the surge arrestor cap cavity, and is held in place inside the surge arrestor cap cavity. Thus, access to the gas tube is provided by removing the surge arrestor cap, for example, by unscrewing the surge arrestor cap from the remainder of the surge arrestor assembly.

### BACKGROUND OF THE INVENTION

The invention relates to surge protection circuitry. More particularly, the invention relates to a gas tube holder for gas tube surge arrestors.

Electrical power surges can cause equipment failure. Surges can be transient in nature, and may be caused by events such as lightning strikes, short-circuited power lines, or power supply failure. Equipment failure results from failure of electrical circuits that are unable to handle high energy signals.

Transient, or surge protection devices protect equipment from failure by providing a path to ground for high energy signals, so that the high energy signals bypass downstream equipment. A common method of implementing a surge protection device is to provide a low resistance path to ground which is usually disconnected from downstream equipment to be protected but becomes connected to the downstream equipment when a high energy signal is sensed.

One type of surge protection device uses a gas tube as the low resistance path to ground. A gas tube filled with a gas that ionizes upon sensing a high energy signal is electrically connected to the equipment to be protected. When the gas ionizes, the gas in the gas tube becomes a low resistance path to ground. Because the gas tube contains the conducting element that provides the electrical isolation of the equipment from ground, it may be beneficial to have an easily replaceable gas tube for maintenance, repair, or installation purposes.

One way of achieving this is to design gas tubes with holders that keep the gas tubes in good electrical contact with the equipment to be protected and which facilitate easy removal of the gas tubes. Typically, one end of the gas tube is housed inside a surge arrestor cap that fits into the body of the surge arrestor so that when the surge arrestor cap is removed from the body of the surge arrester, the gas tube is removed simultaneously, as illustrated in FIG. 1. FIG. 1 shows surge arrestor 100 that includes surge arrestor cap 102 with cavity 104, annular seal 106, spring clip 108, gas tube 110, center disk 112, and conductor 114 (conductor 114 is part of the equipment to be protected by surge arrestor 100). Spring clip 108 fits into cavity 104, and has to be installed into cavity 104 separately from the installation of gas tube 110 into spring clip 108. When surge arrestor 100 senses a high energy signal, gas tube 110 starts conducting and diverting current from conductor 114, and passes the current through spring clip 108 to surge arrestor cap and to ground (not shown in FIG. 1). Other gas tube surge arrestors have not included spring clips, but have used other types of holders, in addition to surge arrestor caps, in order to connect the gas tube to both ground and the equipment to be protected. Disadvantages of such surge arrestor designs include the additional costs of manufacturing and proper installation of gas tubes with respect to the holders, and the holders with respect to the surge arrestor cap. Also, regardless of whether holders or spring clips are used, the spring clip or holder has the dual function of holding itself in place inside the surge arrestor cap and attaching itself to the gas tube.

Therefore, it is desirable to provide a gas tube holder that eliminates the need for a separate holder, and that is integrated with the surge arrestor cap.

### SUMMARY OF THE INVENTION

It is an object of the invention to provide a gas tube holder that eliminates the need for a separate holder, and that is integrated with the surge arrestor cap. Gas tube surge arrestors are commonly placed at the junction between two coaxial lines and are electrically placed in series between a first coaxial line that leads to equipment and a second coaxial line that leads away from the equipment. The gas tube surge arrestor can include housing to contain the conductor between the two coaxial lines at the junction, and to accommodate the gas tube which provides the low resistance path for high energy transient signals.

A surge arrestor cap shaped like a bolt that screws into the housing can be manufactured with a cavity that is designed to mate with the gas tube directly, without use of a separate holder or spring clip. One end of the gas tube can be securely fitted inside the cavity of the surge arrestor cap with an interference fit, while the other end of the gas tube makes electrical contact with the conductor. In one embodiment of the invention, the part of the cap containing the cavity can include slits that cause the cavity to expand to allow the gas tube to be pushed into the cavity while providing pushing inwards on the gas tube to hold the gas tube in place. Alternatively, protuberances can line the cavity to provide an interference fit with the electrode of the gas tube. Thus, access to the gas tube is provided by removing the surge arrestor cap, for example, by unscrewing the surge arrestor cap from the remainder of the surge arrestor housing. Upon passage of a high energy transient signal, the gas in the gas tube ionizes, causing current to flow through the gas tube, and through the surge arrestor cap. The current then flows through the surge arrestor cap, and to ground via the housing of the surge arrestor, which is coupled to ground.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is a diagram of a typical gas tube surge arrestor;

FIG. 2A is a side view of a surge arrestor cap according to the invention;

FIG. 2B is a longitudinal cross-section view of a surge arrestor cap according to the invention;

FIG. 3A is a top view of a surge arrestor cap according to the invention;

FIG. 3B is a bottom view of a surge arrestor cap according to the invention;

FIG. 3C is a side view of a surge arrestor cap according to the invention;

FIG. 3D is a partial longitudinal cross-section view of a surge arrestor cap according to the invention;

FIG. 3E is a bottom view of a surge arrestor cap according to the invention; and

FIG. 4 is a partial side view of a surge arrestor installation according to the invention.

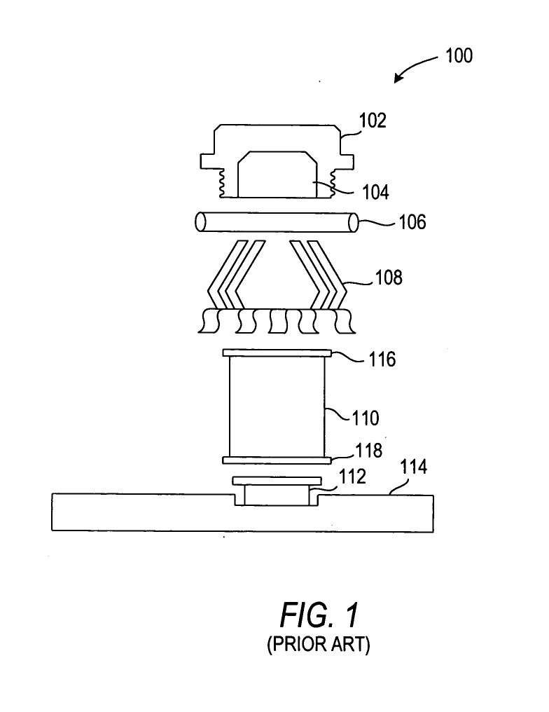

### DETAILED DESCRIPTION OF THE INVENTION

Gas tube surge arrestors typically include gas tubes that provide low resistance paths upon the sensing of a high energy transient signal. The gas tubes are filled with gases that ionize when subjected to high current and/or voltages. Thus, the gas has to maintain electrical contact with the equipment to be protected. Electrical contact is provided by having one electrode at one end of the gas tube in contact with the equipment to be protected, while another electrode at the other end of the gas tube is connected to ground, or any electric potential suitable for discharging high energy signals.

One approach that is used to connect the electrode to ground is to fit the electrode inside a metal cap, which is in electrical contact with ground. The metal cap can also be fitted to the electrode such that when the metal cap is removed, the gas tube is removed from the installation. The metal cap is advantageously shaped like a bolt, for ease of installation, and has a cavity at one end to hold one end of the gas tube. The cavity can be made to have an interference fit or press fit to accommodate the installation of one end of the gas tube into the metal cap. In one embodiment, the surge arrestor cap is tapered, with slits that cause the cavity to expand and accommodate the installation of one end of the gas tube into the metal cap while providing a compressive force to secure the gas tube in place. Alternatively, the cavity can be lined with protuberances to accommodate the installation of one end of the gas tube into the metal cap, wherein the protuberances provide the compressive force to secure the gas tube in place.

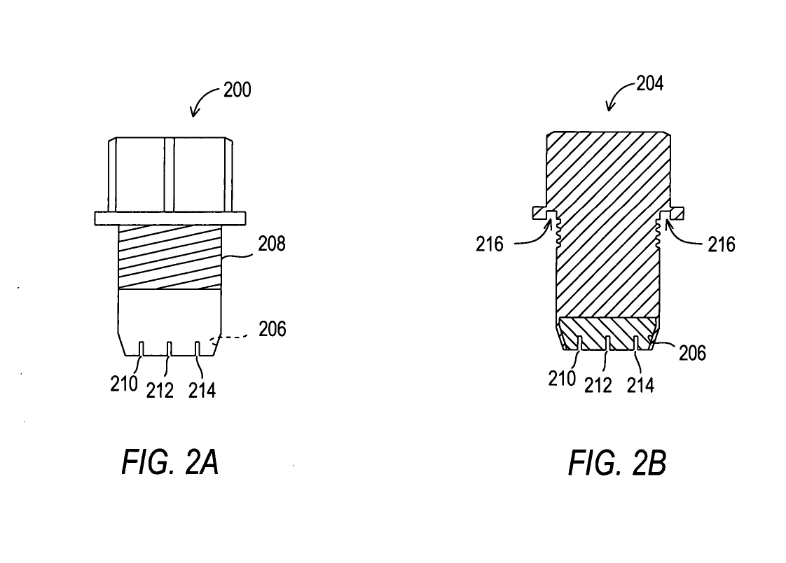

FIGS. 2A and 2B show side view 200 and longitudinal cross-section 204 of one embodiment of a surge arrestor cap in accordance with the invention. As shown in side view 200, the surge arrestor cap resembles a threaded bolt, with threads 208 near the top of the surge arrestor cap. The surge arrestor cap can be installed into the housing for the surge arrestor with a simple tool, such as a wrench. Shaft 206 of the surge arrestor cap is tapered at one end, and is slitted, as shown in FIG. 2A with evenly spaced slits (of which slits 210, 212, and 214 are shown). The tapered end of the surge arrestor cap is hollow and is ringed by slits (the cavity formed inside the surge arrestor cap is not visible from side view 200). Longitudinal cross-section 204 of FIG. 2B shows cavity 206. The slits (of which slits 210, 212, and 214 are shown) cause the sides of the surge arrestor cap to provide spring force or press-fit pressure inwards to keep one end of the gas tube fitted inside cavity 206 upon installation of the gas tube. When the surge arrestor cap is unscrewed from an installation, the gas tube is removed along with the surge arrestor cap. A rubber seal such as an O-Ring seal can be inserted in space 216 to provide isolation between the surge arrestor cap and the housing of the surge arrestor. When the surge arrestor cap is installed in surge arrestor housing with a seal, the seal provides some flexibility in how tightly the surge arrestor cap is installed in surge arrestor housing, as well as compression and moisture sealing.

The surge arrestor cap and the gas tube may be of varying dimensions for different types of installations. However, in one embodiment of the invention, the gas tube is 8.0 mm (with a tolerance of +0.1, −0.3 mm) in diameter and 6.05 mm (with a tolerance of +0.2, −0.15 mm) in length. In this embodiment of the invention, the surge arrestor cap is preferably made of brass with alloy plating (typically tin, copper and zinc). The cavity is 8.7 mm (measured at the outer wall, with a tolerance of ±0.1 mm) in diameter at the open end of the surge arrestor cap, 8.9 mm (measured at the outer wall, with a tolerance of ±0.1 mm) in diameter at the blind end of the surge arrestor cap, and 15.75 mm or 13.75 mm in length (because the length will vary with the type of gas tube used, with a tolerance of ±0.25 mm). The slits can be at least four, but typically six in number, 2.54 mm (with a tolerance of ±0.1 mm) in length, 0.50 mm (with a tolerance ±0.25 mm) in width. The seal around the surge arrestor cap has an outside diameter of 15.0 mm (with a tolerance of ±0.2 mm) and an inside diameter of 10 mm (with a tolerance of 0.2 mm).

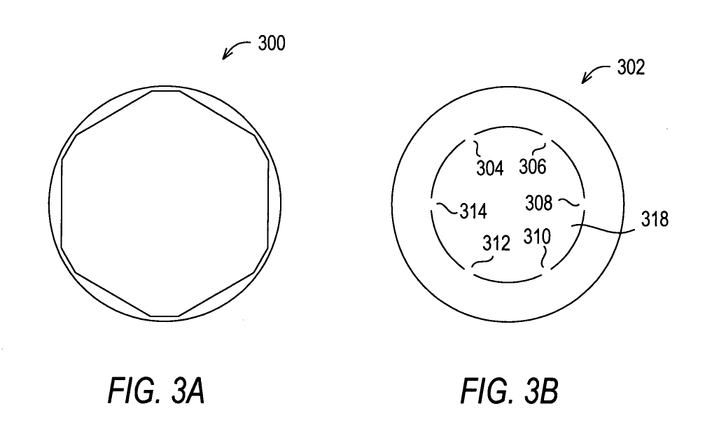

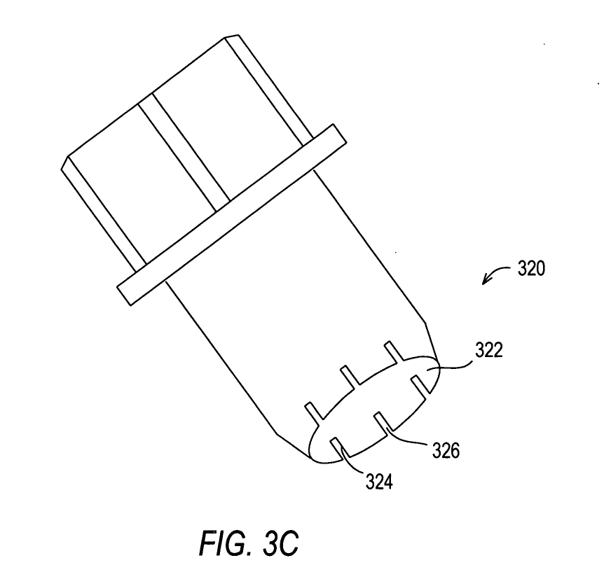

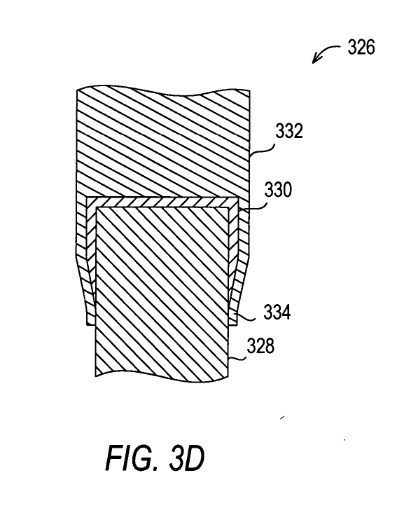

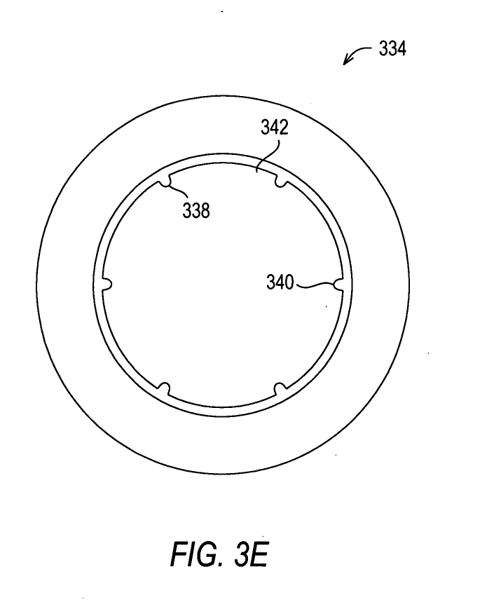

FIG. 3A shows top view 300 of the surge arrestor cap of a gas tube surge arrestor, which can be shaped like a hexagonal bolt for ease of installation with a simple tool. Alternatively, the surge arrestor cap can be shaped like a slotted screw, or a Philips screw or any type of bolt or screw that can be installed into a surge arrestor easily. FIG. 3B shows bottom view 302 of the surge arrestor cap, with cavity 318. One electrode of the gas tube used in the surge arrestor can be inserted into cavity 318 and is held in place because slits 304, 306, 308, 310, 312 and 314, which are evenly spaced around the tapered end of the surge arrestor cap cause the sides of the surge arrestor cap to provide spring force or press-fit pressure inwards to hold the gas tube, while expanding the cavity to allow insertion. Thus, the necessity for a separate holder for the gas tube is advantageously eliminated. FIG. 3C shows another view of the surge arrestor cap. As illustrated in FIG. 3C, surge arrestor cap 320 contains cavity 322 at its tapered end, which also contains slits (for example, slits 324 and 336).

Thus, as illustrated in FIGS. 2A-B and 3A-C, one end of the surge arrestor cap is tapered. The cavity inside the surge arrestor cap can similarly be tapered, i.e., the cavity is narrower at one end than the other. As a result, the spring force or press-fit pressure is applied by the sides of the surge arrestor cap at the narrower end of the cavity to the gas tube. FIG. 3D is a partial longitudinal cross-sectional view of the surge arrestor cap. Cross-sectional view 326 shows gas tube 328 partially inserted into cavity 320 of surge arrestor cap 332. Tapered portion 334 of surge arrestor cap 332 exerts spring force or press-fit pressure on gas tube 328 to hold gas tube 328 in place.

An alternative embodiment of the surge arrestor cap is illustrated in FIG. 3E. Instead of using slits in the base of the surge arrestor cap, protuberances can be placed inside cavity 342 of the surge arrestor cap. FIG. 3E shows bottom view 334 of an embodiment of the surge arrestor cap that uses protuberances. The protuberances are used instead of the slits to provide spring pressure inwards upon insertion of a gas tube into cavity 342.

Once the gas tube has been secured inside the surge arrestor cap, the surge arrestor cap can be installed in surge arrestor housing. Because of the pressure exerted by the tapered portion of the surge arrestor cap on the gas tube, the gas tube does not have to be completely inserted into the cavity of the surge arrestor cap. When the gas tube is secured inside the surge arrestor cap, the surge arrestor cap can be screwed into surge arrestor housing with an appropriate amount of axial pressure so that one electrode of the gas tube is in electrical contact with the surge arrestor cap and the other electrode is in contact with the surge arrestor housing.

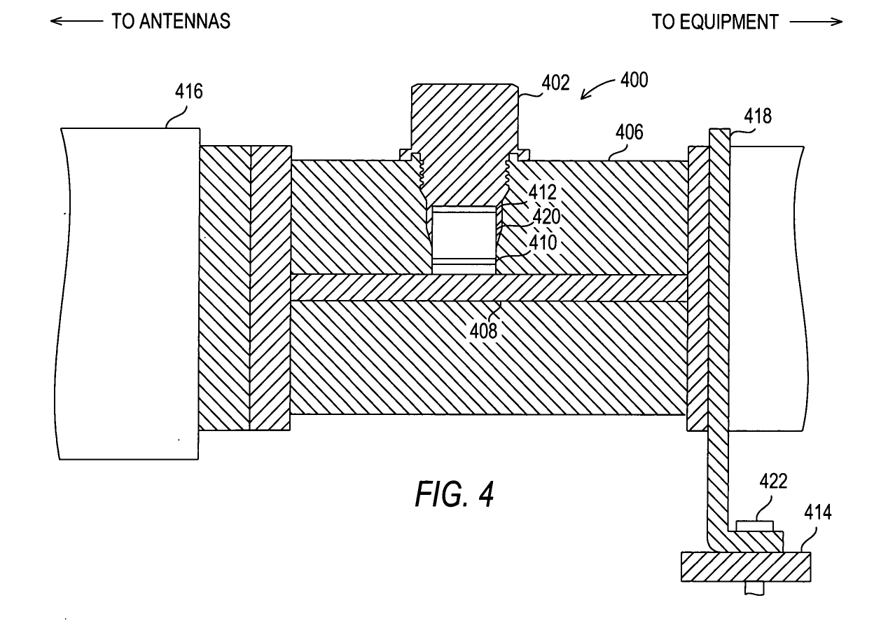

FIG. 4 shows a typical gas tube surge arrestor 400 installed in accordance with the invention. Surge arrestor cap 402 is screwed into surge arrestor housing 406 by applying axial pressure in the direction towards surge arrestor cap 402. A first electrode 412 is fitted inside surge arrestor cap 402, and thus makes electrical contact with surge arrestor cap 402, and surge arrestor housing 406. The surge arrestor is typically coupled between two coaxial lines, coaxial line 416 and coaxial line 418. Coaxial line 416 can be coupled to radio antennas, for example, and coaxial line 418 can be coupled to radio equipment, for example.

When there is a high energy transient electrical signal, gas tube 420 can ionize and cause current to be diverted from conductor 408 through electrode 410 to the gas in gas tube 420, from the gas in gas tube 420 to electrode 412 and through surge arrestor cap 402. The current then flows from surge arrestor cap to housing 406 to bracket 418 to ground bar 414. Ground bar 414 is preferably coupled to bracket 418 with suitable hardware, such as bolt 422.

Thus it is seen that a gas tube holder is provided that eliminates the need for a separate holder, and that is integrated with the surge arrestor cap. One skilled in the art will appreciate that the present invention can be practiced by other than the described embodiments, which are presented for purposes of illustration and not of limitation, and the present invention is limited only by the claims which follow.

I claim:

1. A surge arrestor cap for holding a gas tube used in a gas tube surge arrestor, wherein:
the gas tube comprises a first electrode and a second electrode, each electrode located at each opposing end of the gas tube; and
the surge arrestor cap comprises:
a cavity at a first end of the surge arrestor cap for holding a portion of the gas tube, wherein at least a portion of the cavity is sized to have a interference fit with the gas tube; and
a plurality of slits at the first end of the surge arrestor cap.

2. The surge arrestor cap of claim 1, wherein the surge arrestor cap is substantially shaped like a bolt, comprising a head and a shaft.

3. The surge arrestor cap of claim 1, wherein the surge arrestor cap is substantially shaped like a slotted screw, comprising a head and a shaft.

4. The surge arrestor cap of claim 2, wherein the surge arrestor cap comprises threads near the head of the surge arrestor cap for installation of the surge arrestor cap into the gas tube surge arrestor.

5. The surge arrestor cap of claim 2, wherein the cavity in the surge arrestor cap is situated inside the shaft of the surge arrestor cap, at the base of the shaft of the surge arrestor cap.

6. The surge arrestor cap of claim 3, wherein the cavity in the surge arrestor cap is situated inside the shaft of the surge arrestor cap, at the base of the shaft of the surge arrestor cap.

7. A surge arrestor cap for holding a gas tube used in a gas tube surge arrestor, wherein:
the surge arrestor cap comprises:
a cavity at a first end of the surge arrestor cap for holding a portion of the gas tube, wherein at least a portion of the cavity is sized to have a interference fit with the gas tube; and
at least one protuberance inside the cavity.

8. The surge arrestor cap of claim 7, wherein the surge arrestor cap is substantially shaped like a bolt, comprising a head and a shaft.

9. The surge arrestor cap of claim 7, wherein the surge arrestor cap is substantially shaped like a slotted screw, comprising a head and a shaft.

10. The surge arrestor cap of claim 8, wherein the cavity in the surge arrestor cap is situated inside the shaft of the surge arrestor cap, at the base of the shaft of the surge arrestor cap.

11. The surge arrestor cap of claim 9, wherein the cavity in the surge arrestor cap is situated inside the shaft of the surge arrestor cap, at the base of the shaft of the surge arrestor cap.

12. A surge arrestor cap for holding a gas tube used in a gas tube surge arrestor, wherein:
the gas tube comprises a first electrode and a second electrode, each electrode located at each opposing end of the gas tube; and
the surge arrestor cap comprises:
a cavity at a first end of the surge arrestor cap for holding a portion of the gas tube, wherein at least a portion of the cavity is sized to have a interference fit with the gas tube;
a plurality of slits at the first end of the surge arrestor cap; and
a rubber seal fitted around the surge arrestor cap.

13. The surge arrestor cap of claim 12, wherein the surge arrestor cap is substantially shaped like a bolt, comprising a head and a shaft.

14. The surge arrestor cap of claim 12, wherein the surge arrestor cap is substantially shaped like a slotted screw, comprising a head and a shaft.

15. The surge arrestor cap of claim 13, wherein the cavity in the surge arrestor cap is situated inside the shaft of the surge arrestor cap, at the base of the shaft of the surge arrestor cap.

16. The surge arrestor cap of claim 14, wherein the cavity in the surge arrestor cap is situated inside the shaft of the surge arrestor cap, at the base of the shaft of the surge arrestor cap.
